(19) United States
(12) Patent Application Publication
(10) Pub. No.: US 2017/0229786 A1
(43) Pub. Date: Aug. 10, 2017

(54) Antenna System and Processing Method

(71) Applicant: Huawei Technologies Co., Ltd., Shenzhen (CN)

(72) Inventors: Keli Zou, Chengdu (CN); Hua Cai, Chengdu (CN)

(21) Appl. No.: 15/495,681

(22) Filed: Apr. 24, 2017

Related U.S. Application Data
(63) Continuation of application No. PCT/CN2014/089484, filed on Oct. 24, 2014.

(51) Int. Cl. H01Q 21/30; H01Q 15/16; H01Q 15/02

(52) U.S. Cl. CPC H01Q 21/30; H01Q 15/02; H01Q 15/16; H01Q 19/30

(57) ABSTRACT

An antenna system and a processing method are provided. The antenna system includes a focus device and a multi-band feeding antenna array that is disposed in a focus area of the focus device, where the multi-band feeding antenna array includes antenna arrays on at least two frequency bands, the antenna arrays on the at least two frequency bands include at least an antenna array on a first target frequency band, the antenna array on the first target frequency band includes multiple feeding units that are arranged in a form of a non-one-dimensional linear array; the multi-band feeding antenna array is configured to radiate a first beam, where the first beam points to the focus device, and sub-beams separately generated by the antenna arrays on the at least two frequency bands constitute the first beam.

### CROSS-REFERENCE TO RELATED APPLICATIONS

This Application is a continuation of International Application No. PCT/CN2014/089484, filed on Oct. 24, 2014, the disclosure of which is hereby incorporated by reference in its entirety.

### TECHNICAL FIELD

Embodiments of the present invention relate to the communications field, and more specifically, to an antenna system and a processing method.

### BACKGROUND

With development of emerging applications, people impose increasingly high requirements on information services; for example, from conventional voice communication to high-definition video communication; for another example, appearance of an Internet of Everything concept. Therefore, demands for a communications capacity of a communications system increase explosively.

There are many factors restricting the communications capacity, such as an antenna gain, a radiant power, a radio frequency distortion, a modulation order, and a communications bandwidth. The communications capacity is in a linear relationship with the communications bandwidth. Therefore, the communications bandwidth is a key factor restricting the communications capacity. Correspondingly, extending the communications bandwidth is an important way to increase the communications capacity.

A dual-frequency antenna or a multi-band antenna refers to an antenna that can work on two or more frequency bands at the same time, and can effectively extend a communications bandwidth of a communications system, so as to further increase a communications capacity of the communications system.

Currently, a solution of a dual-band shared-aperture antenna based on X and Ka frequency bands is disclosed. In this solution, all antennas that work on the X and Ka frequency bands are waveguide slot antennas. An X-frequency band antenna whose frequency is relatively low and wavelength is relatively long is located at a lower layer, and an X antenna unit is located at a slot between Ka waveguides and radiates a signal by using the slot; a Ka-frequency band antenna whose frequency is relatively high and wavelength is relatively short is located at an upper layer and directly radiates a signal outwards. In addition, in this solution, a frequency band ratio of the X and Ka frequency bands needs to be close to an integer multiple. It may be learned that, in the solution of the dual-band shared-aperture antenna based on the X and Ka frequency bands, a radiation slot on a lower frequency band needs to be located at a slot between antennas on a higher frequency band, and this greatly limits structures of antennas on the two frequency bands and also limits frequency band ratio of the two frequency bands. In addition, the antennas on the two frequency bands use waveguide structures. Therefore, the dual-band shared-aperture antenna solution greatly limits applicability of the solution, and it is difficult for the solution to effectively increase a communications capacity.

### SUMMARY

Embodiments of the present invention provide an antenna system and a processing method that can effectively increase a communications capacity.

A first aspect provides an antenna system. The antenna system includes: a focus device, having a beam focusing function. The antenna system also includes a multi-band feeding antenna array, disposed in a focus area of the focus device, and configured to radiate a first beam, where the first beam points to the focus device, and a distance between a boundary point of the focus area and a focal point of the focus device is less than a first threshold. The focus device is configured to receive the first beam radiated by the multi-band feeding antenna array, and output a second beam based on the first beam, where a gain of the second beam is greater than a gain of the first beam. The multi-band feeding antenna array includes antenna arrays on at least two frequency bands, where an antenna array on each frequency band of the at least two frequency bands includes a feeding unit that is configured to receive a feeding signal and generate a sub-beam based on the feeding signal, and sub-beams separately generated by the antenna arrays on the at least two frequency bands constitute the first beam. The antenna arrays on the at least two frequency bands include at least an antenna array on a first target frequency band, where the antenna array on the first target frequency band includes multiple feeding units that are arranged in a form of a non-one-dimensional linear array.

A second aspect provides a processing method for an antenna system. The antenna system includes a focus device and a multi-band feeding antenna array. The focus device has a beam focusing function. The multi-band feeding antenna array is disposed in a focus area of the focus device, a distance between a boundary point of the focus area and a focal point of the focus device is less than a first threshold. The multi-band feeding antenna array includes antenna arrays on at least two frequency bands. An antenna array on each frequency band of the at least two frequency bands includes a feeding unit that is configured to receive a feeding signal and generate a sub-beam based on the feeding signal. The method includes: the multi-band feeding antenna array is configured to radiate a first beam, where the first beam points to the focus device, and sub-beams separately generated by the antenna arrays on the at least two frequency bands constitute the first beam. The focus device is configured to receive the first beam radiated by the multi-band feeding antenna array, and output a second beam based on the first beam, where a gain of the second beam is greater than a gain of the first beam. The antenna arrays on the at least two frequency bands include at least an antenna array on a first target frequency band, where the antenna array on the first target frequency band includes multiple feeding units that are arranged in a form of a non-one-dimensional linear array.

Based on the foregoing technical solutions, in the antenna system and the processing method provided in the embodiments of the present invention, a multi-band feeding antenna array that includes antenna arrays on at least two frequency bands is disposed in a focus area of a focus device, where the multi-band feeding antenna array includes at least an antenna array, on a first target frequency band, that includes multiple feeding units arranged in a form of a non-one-dimensional linear array, so that a coverage area of a beam on the first target frequency band can be effectively extended, thereby effectively increasing a communications capacity.

### BRIEF DESCRIPTION OF THE DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 shows a schematic block diagram of an antenna system according to an embodiment of the present invention;

FIG. 2(a) and FIG. 2(b) and FIG. 2(c) and FIG. 2(d) and FIG. 2(e) show a schematic diagram of a focus device according to an embodiment of the present invention;

FIG. 3 shows a schematic diagram of an antenna system according to an embodiment of the present invention;

FIG. 4(a) and FIG. 4(b) show a schematic diagram of an arrangement manner of feeding units according to an embodiment of the present invention;

FIG. 5(a) and FIG. 5(b) and FIG. 5(c) show a schematic diagram of an arrangement manner of antenna arrays on different frequency bands according to an embodiment of the present invention;

FIG. 6(a) and FIG. 6(b) and FIG. 6(c) show a schematic diagram of a processing method for an antenna system according to an embodiment of the present invention;

FIG. 7 shows another schematic diagram of a processing method for an antenna system according to an embodiment of the present invention;

FIG. 8 shows still another schematic diagram of a processing method for an antenna system according to an embodiment of the present invention; and

FIG. 9 shows yet still another schematic diagram of a processing method for an antenna system according to an embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

For convenience of understanding technical solutions in the embodiments of the present invention, several relevant concepts are described first herein.

(1) Antenna

An antenna is an electronic device used to transmit or receive a radio wave or an electromagnetic wave. Speaking physically, the antenna is a combination of one or more conductors. A radiation electromagnetic field may be generated by applying an alternating voltage and a related alternating current to the antenna, or the antenna may be disposed in an electromagnetic wave, so that an alternating current is generated inside the antenna because of field induction and an alternating voltage is generated in an antenna terminal. An antenna bandwidth refers to a frequency range within which the antenna can effectively work.

(2) Antenna Gain

An antenna gain refers to a power density ratio of signals respectively generated at a same point in space by an actual antenna and an ideal radiating element (a nondirectional antenna) in a case of same input power. The antenna gain quantificationally describes a degree that an antenna centrally radiates input power. That is, the antenna gain is used to measure a capability of receiving and transmitting a signal towards a specific direction by the antenna. The antenna gain is one of important parameters to choose a base station antenna.

The antenna gain is closely related to an antenna radiation pattern. When a main lobe of the radiation pattern is narrower, a side lobe is smaller, and the antenna gain is higher. The antenna radiation pattern is a figure description of transmitting or receiving relative field strength by the antenna. The antenna radiation pattern may be also referred to as an antenna pattern or a far-field pattern.

(3) Antenna Array

Directivity of a single antenna is limited. To meet application on various occasions, two or more single antennas that work on a same frequency are fed and spatially arranged according to specific requirements to constitute an antenna array. Antenna radiating elements that constitute the antenna array are referred to as array elements.

A working principle of the antenna array may be considered as superposition of electromagnetic waves. For several arrays of electromagnetic waves, when the electromagnetic waves are transmitted to a same area, vector superposition of the electromagnetic waves is generated according to a superposition principle. A superposition result is not only related to an amplitude of each array of electromagnetic waves, but also related to a phase difference between the several arrays of electromagnetic waves in a meet area. A space phase difference caused when electromagnetic waves sent by transmit antennas at different locations are transferred to a same receiving area certainly causes the several arrays of electromagnetic waves to experience the following two cases in the meet area: Same phases are superposed, and total field strength is strengthened; and antiphases are superposed, and total field strength is weakened. If a strengthening area and a weakening area of the total field strength are kept relatively fixed in space, a radiation field structure of a single antenna is changed by using an antenna array, that is, the antenna array changes a radiation field magnitude and a directivity principle.

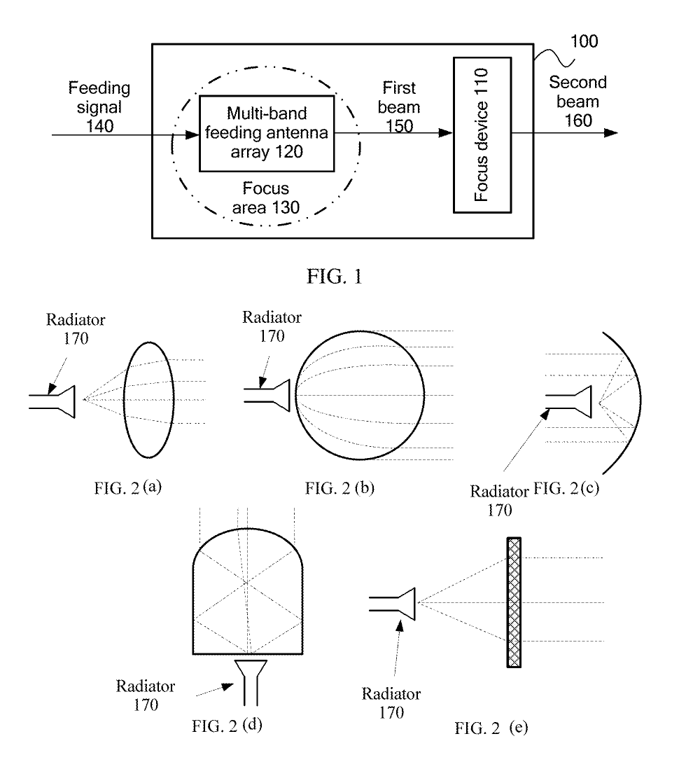

FIG. 1 is a schematic block diagram of an antenna system according to an embodiment of the present invention. As shown in FIG. 1, an antenna system 100 includes a focus device 110 and a multi-band feeding antenna array 120. The focus device 110 has a beam focusing function. The multi-band feeding antenna array 120 is disposed in a focus area 130 of the focus device 110, and is configured to radiate a first beam 150, where the first beam 150 points to the focus device 110, and a distance between a boundary point of the focus area and a focal point of the focus device is less than a first threshold. The focus device 110 is configured to output a second beam 160 according to the first beam 150 radiated by the multi-band feeding antenna array, where a gain of the second beam 160 is greater than a gain of the first beam 150. The multi-band feeding antenna array 120 includes antenna arrays on at least two frequency bands, where an antenna array on each frequency band of the at least two frequency bands includes a feeding unit that is configured to receive a feeding signal 140 and generate a sub-beam based on the feeding signal, and sub-beams separately generated by the antenna arrays on the at least two frequency bands constitute the first beam 150; and the antenna arrays on the at least two frequency bands include at least an antenna array on a first target frequency band, where the antenna array on the first target frequency band includes multiple feeding units that are arranged in a form of a non-one-dimensional linear array.

Therefore, in the antenna system provided in this embodiment of the present invention, a multi-band feeding antenna array that includes antenna arrays on at least two frequency bands is disposed in a focus area of a focus device, where the multi-band feeding antenna array includes at least an antenna array, on a first target frequency band, that includes multiple feeding units arranged in a form of a non-one-dimensional linear array, so that a coverage area of a beam on the first target frequency band can be effectively extended, thereby increasing a communications capacity.

Optionally, in this embodiment of the present invention, the focus device includes any one of following devices: an elliptical lens, a spherical lens, an extended hemispherical lens, a Luneburg lens, a paraboloidal reflector, a plane lens, or a Cassegrain dual reflector.

Specifically, as shown in FIG. 2(a) and FIG. 2(b) and FIG. 2(c) and FIG. 2(d) and FIG. 2(e), FIG. 2(a) shows a schematic diagram of the elliptical lens. FIG. 2(b) shows a schematic diagram of the Luneburg lens. FIG. 2(c) shows a schematic diagram of the paraboloidal reflector. FIG. 2(d) shows a schematic diagram of the extended hemispherical lens. FIG. 2(e) shows a schematic diagram of the plane lens. In FIG. 2(a) and FIG. 2(b) and FIG. 2(c) and FIG. 2(d) and FIG. 2(e), 170 is a radiator, and may transmit an electromagnetic wave or an optical wave to the foregoing various types of focus devices. As shown in FIG. 2(a), the radiator 170 transmits electromagnetic wave beams to the elliptical lens at a focal point location of the elliptical lens. These beams are transmitted in parallel after passing through the elliptical lens. As shown in FIG. 2(c), the radiator 170 transmits electromagnetic wave beams to the paraboloidal reflector at a focal point location of the paraboloidal reflector. These beams are transmitted in parallel after being reflected by the paraboloidal reflector. As shown in FIG. 2(d), the radiator 170 transmits electromagnetic wave beams to the extended hemispherical lens at a focal point location of the extended hemispherical lens. These beams are transmitted in parallel after passing through optical paths of the extended hemispherical lens.

It should be understood that, the focus device 110 may be any other apparatus that has an electromagnetic wave beam convergence function. This embodiment of the present invention does not impose a limitation thereto.

The focus area 130 is an area near the focal point of the focus device 110. The distance between the boundary point of the focus area 130 and the focal point of the focus device is less than the first threshold, and the first threshold may be adaptively determined according to actual requirements. It should be understood that, the focus area 130 may be considered as a space area that is centered on the focal point of the focus device 110. This embodiment of the present invention does not strictly limit a space size or a shape of the focus area 130, provided that after the first beam 150 transmitted from the focus area 130 is irradiated by the focus device 1100, the second beam 160 that has an additional gain compared with the first beam 150 can be generated.

Optionally, in this embodiment of the present invention, antenna types of the antenna arrays on the at least two frequency bands include any one of the following types: a coaxial fed microstrip antenna, a direct feeding microstrip antenna, a coupled feed microstrip antenna, a waveguide slot antenna, a Yagi-Uda antenna, a plane Yagi antenna, a substrate-integrated waveguide slot antenna, a rectangular horn antenna, or a dipole antenna.

Specifically, for example, the multi-band feeding antenna array is a tri-band feeding antenna array. An antenna type of an antenna array on a frequency band 1 is a coaxial fed microstrip antenna, an antenna type of an antenna array on a frequency band 2 is a coupled feed microstrip antenna, and an antenna type of an antenna array on a frequency band 3 is a rectangular horn antenna. For another example, all antenna types of the antenna arrays on the three frequency bands are coaxial fed microstrip antennas. Alternatively, for still another example, antenna types of the antenna arrays on the frequency band 1 and the frequency band 2 are waveguide slot antennas, and the antenna type of the antenna array on the frequency band 3 is a dipole antenna. That is, in the antenna system provided in this embodiment of the present invention, antenna types of antenna arrays on different frequency bands may be totally the same, or partially the same, or totally different. This embodiment of the present invention does not impose a limitation thereto.

It should be further understood that in addition to the foregoing described types, the antenna types of the antenna arrays on the at least two frequency bands may be further any other devices that have a function of radiating an electromagnetic wave beam. This embodiment of the present invention does not impose a limitation thereto.

In this embodiment of the present invention, an antenna array on each frequency band of the multi-band feeding antenna array 120 includes a feeding unit that is configured to receive a feeding signal and generate a sub-beam based on the feeding signal, where the feeding unit may be also referred to as an antenna unit. It should be understood that, the first beam 150 transmitted to the focus device 110 by the multi-band feeding antenna array 120 includes sub-beams (equivalent to sub-beams generated by the feeding unit included in the antenna array) separately generated by the antenna array on each frequency band.

The multi-band feeding antenna array 120 is disposed in the focus area 130 near the focal point of the focus device 1100, and a radiation beam main lobe of the first beam 150 radiated by the multi-band feeding antenna array 120 points to the focus device 110. An electromagnetic wave beam (the second beam 160) that has a higher gain can be obtained by using the electromagnetic wave beam convergence function of the focus device 110.

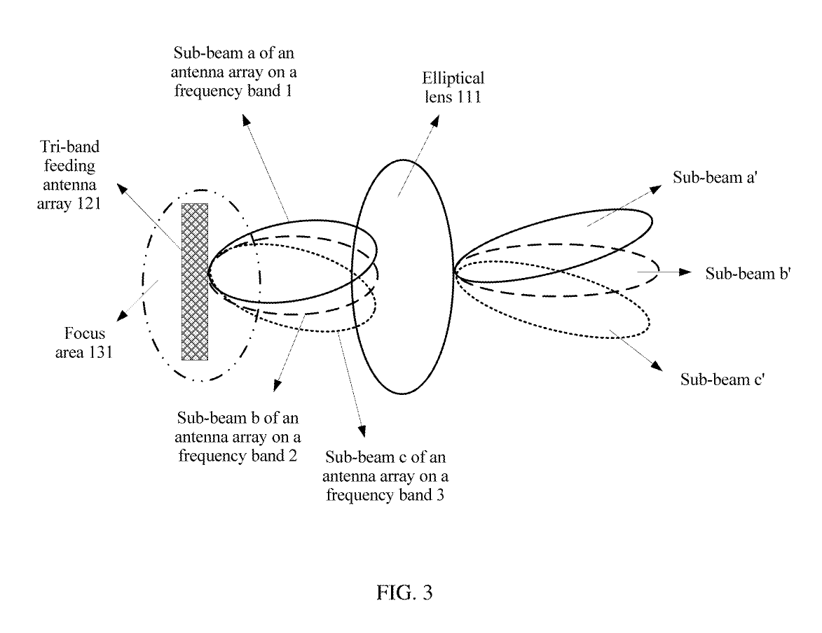

Specifically, as shown in FIG. 3, for example, the focus device 110 is an elliptical lens 111, and the multi-band feeding antenna array 120 is a tri-band feeding antenna array 121 that includes antenna arrays on three frequency bands. As shown in FIG. 3, the tri-band feeding antenna array 121 is disposed in a focus area 131 of the elliptical lens 111. For example, the antenna arrays on the three frequency bands of the tri-band feeding antenna array 121 respectively radiate a radiation sub-beam a on a frequency band 1, a radiation sub-beam b on a frequency band 2, and a radiation sub-beam c on a frequency band 3, and all the sub-beams a, b, and c are irradiated by the elliptical lens 111. By using a beam focusing principle of the elliptical lens 111, sub-beams a′, b′, and c′ are generated on the other side of the elliptical lens 111, and gains of the sub-beams a′, b′, and c′ are respectively greater than gains of the sub-beams a, b, and c, that is, the sub-beams a′, b′, and c′ have an additional gain respectively compared with the sub-beams a, b, and c.

It should be understood that, comparing FIG. 1 with FIG. 3, in FIG. 3, the sub-beams a, b, and c radiated by the antenna arrays on the three frequency bands of the tri-band feeding antenna array 121 constitute a first beam 150 of the tri-band feeding antenna array 121. Correspondingly, the sub-beams a′, b′, and c′ generated after passing through the elliptical lens 111 constitute a second beam 160 of the elliptical lens 111 (the focus device 110). Correspondingly, in the example shown in FIG. 3, that a gain of the second beam 160 is greater than a gain of the first beam 150 specifically means that the sub-beams a′, b′, and c′ have an additional gain respectively compared with the sub-beams a, b, and c.

In the antenna system provided in this embodiment of the present invention, various gains required by the antenna system can be implemented by adjusting performance of the focus device 110.

Therefore, in the antenna system of this embodiment of the present invention, additional antenna gains can be obtained by disposing a multi-band feeding antenna array in a focus area of a focus device and using a beam convergence function of the focus device, and different gain requirements of the antenna system can be satisfied by choosing different types of focus devices or adjusting a design of the focus device. Compared with a dual-band shared-aperture antenna on an X and Ka frequency band, the antenna system provided in this embodiment of the present invention does not limit a frequency band ratio between different frequency bands, and does not strictly limit antenna types of antenna arrays on different frequency bands of the multi-band feeding antenna array, so that applicability of the antenna system can be further improved. In addition, the antenna system provided in this embodiment of the present invention does not have a strict limitation on an arrangement manner between the antenna arrays on different frequency bands, provided that antenna arrays on multiple frequency bands are disposed in the focus area 130. Therefore, compared with an existing multi-band antenna system, the antenna system provided in this embodiment of the present invention has higher applicability.

It should be understood that, the feeding signal 140 shown in FIG. 1 is an example feeding signal, and includes a feeding signal received by the feeding unit of the antenna array on each frequency band of the multi-band feeding antenna array 120.

It should be further understood that, it is mentioned in the foregoing that the gain of the second beam 160 is greater than the gain of the first beam 150, where the gain herein refers to the foregoing mentioned “(2) Antenna gain”, that is, a power density ratio of signals respectively generated at a same point in space by an actual antenna and an ideal radiating element (a nondirectional antenna) in a case of same input power. The power density ratio quantificationally describes a degree that an antenna centrally radiates input power.

In this embodiment of the present invention, the antenna array on the first target frequency band includes multiple feeding units (or referred to as antenna units). An arrangement manner of the multiple feeding units is at least two-dimensional, that is, the antenna array on the first target frequency band covers at least a two-dimensional planar array, but not a one-dimensional linear array.

Optionally, in this embodiment of the present invention, the arrangement manner of the multiple feeding units included in the antenna array on the first target frequency band includes either one of the following manners: a two-dimensional planar array or a three-dimensional array.

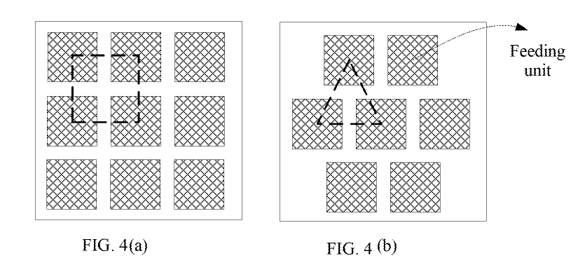

The two-dimensional planar array may specifically include a two-dimensional rectangle planar array, a two-dimensional triangle planar array, or another planar array of any shape. As shown in FIG. 4(a) and FIG. 4(b), FIG. 4(a) shows a two-dimensional rectangle planar array of an antenna array that includes nine feeding units, and FIG. 4(b) shows a two-dimensional triangle planar array of an antenna array that includes seven feeding units. The three-dimensional array means that an arrangement manner of multiple feeding units occupies one three-dimensional space. The multiple feeding units included in the antenna array on the first target frequency band are arranged on a surface of a three-dimensional object, such as a cuboid surface.

It should be understood that, when the arrangement manner of the multiple feeding units included in the antenna array on the first target frequency band is a two-dimensional planar array, coverage areas of multiple beams generated by the multiple feeding units according to feeding signals received by the multiple feeding units are also two-dimensional. That is, sub-beams radiated by the antenna array on the first target frequency band cover at least one plane, but not a one-dimensional linear array, so that coverage of the antenna can be strengthened. If the arrangement manner of the multiple feeding units included in the antenna array on the first target frequency band is three-dimensional, coverage areas of multiple beams generated by the multiple feeding units according to feeding signals received by the multiple feeding units constitute three-dimensional space, so that a coverage area of an antenna electromagnetic wave beam is extended.

Therefore, in the antenna system provided in this embodiment of the present invention, the multi-band feeding antenna array has at least an antenna array, on a first target frequency band, including multiple feeding units that are arranged in a form of a non-one-dimensional linear array, so that a coverage area of beams on the first target frequency band can be effectively extended, thereby increasing a communications capacity.

It should be understood that, the multi-band feeding antenna array may include one or more antenna arrays on the first target frequency band. For example, the antenna array on each frequency band of the antenna arrays, on the two frequency bands, included in the multi-band feeding antenna array includes multiple feeding units, and an arrangement manner of the multiple feeding units is not a one-dimensional linear array. Therefore, a coverage area of beams on each frequency band generated by the antenna system is at least a two-dimensional planar array, and a communications capacity of the antenna system is effectively increased.

It should be further understood that an antenna array on another frequency band except the first target frequency band in the at least two frequency bands may include one or more feeding units. In addition, if multiple feeding units are included, an arrangement manner of the multiple feeding units may be any one of the following manners: a one-dimensional linear array, a two-dimensional planar array, or a three-dimensional array.

Optionally, in this embodiment of the present invention, the antenna arrays on the at least two frequency bands include at least an antenna array on a fourth target frequency band, where the antenna array on the fourth target frequency band includes one feeding unit. The antenna array on the fourth target frequency band may be an antenna array on any one or more frequency bands of other frequency bands except the first target frequency band of the at least two frequency bands.

In a conventional antenna system, because a single antenna unit (equivalent to the feeding unit in this embodiment of the present invention) has a relatively small gain, for a case of a relatively high gain, an antenna array that includes multiple antenna units needs to be used, and each antenna unit of the antenna array needs to be fed. That is, all feeding units of the antenna array generate beams, so as to obtain enough gains. However, in the antenna system that is based on a focus device and provided in this embodiment of the present invention, the focus device can generate any additional gain that is greater than zero for a beam coming from a focus area. Therefore, for an antenna array, on any single frequency band, of a multi-band feeding antenna array disposed in the focus area, a required beam and a required gain can be implemented by feeding a single feeding unit. Therefore, in the antenna system provided in this embodiment of the present invention, there is no need to require an antenna array on each frequency band of antenna arrays on the at least two frequency bands to include multiple feeding units. In addition, even if an antenna array on one frequency band includes multiple feeding units, there is no need to feed all the feeding units when in use. It may be understood that, compared with the conventional antenna system, the antenna system provided in this embodiment of the present invention whose antenna arrays have higher integration can further simplify structures and complexities of the antenna arrays.

It should be understood that, in this embodiment of the present invention, arrangement manners of feeding units of antenna arrays on different bands may be totally the same, or partially the same, or totally different. This embodiment of the present invention does not impose a limitation thereto. For example, the multi-band feeding antenna array 120 is a tri-band feeding antenna array. For example, each of antenna arrays on three frequency bands includes multiple feeding units, where all arrangement manners of the multiple feeding units respectively included in the antenna arrays on the three frequency bands are two-dimensional planar arrays; or, an arrangement manner of multiple feeding units in an antenna array on a frequency band 1 is a one-dimensional linear array, an arrangement manner of multiple feeding units in an antenna array on a frequency band 2 is a two-dimensional planar array, and an arrangement manner of multiple feeding units in an antenna array on a frequency band 3 is a three-dimensional array; or, both arrangement manners of multiple feeding units respectively included in an antenna array on a frequency band 1 and an antenna array on a frequency band 2 are two-dimensional planar arrays, and an arrangement manner of multiple feeding units in an antenna array on a frequency band 3 is a one-dimensional linear array.

Optionally, in this embodiment of the present invention, an arrangement manner between the antenna arrays on the at least two frequency bands of the multi-band feeding antenna array includes any one of the following manners: a partition arrangement, a partially overlapped arrangement, or a completely overlapped arrangement.

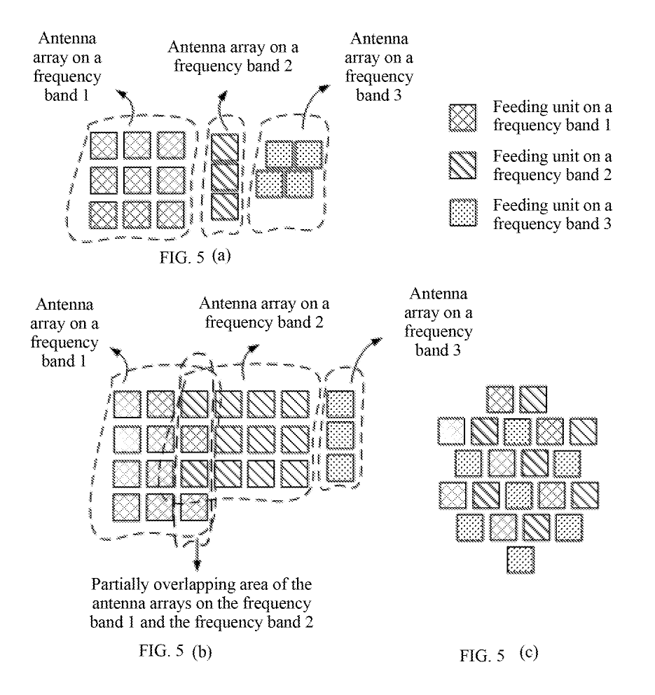

Specifically, as shown in FIG. 5(a) and FIG. 5(b) and FIG. 5(c), for example, the multi-band feeding antenna array is a tri-band feeding antenna array that includes three frequency bands (frequency bands 1, 2, and 3 shown in FIG. 5(a) and FIG. 5(b) and FIG. 5(c)). FIG. 5(a) shows a schematic diagram in which an arrangement manner of antenna arrays on the three frequency bands is a partition arrangement. Correspondingly, coverage space areas of electromagnetic wave beams on the three frequency bands are not overlapped. FIG. 5(b) shows a schematic diagram in which the arrangement manner of the antenna arrays on the three frequency bands is a partially overlapped arrangement. Specifically, as shown in FIG. 5(b), an arrangement area of an antenna array on the frequency band 1 and an arrangement area of an antenna array on the frequency band 2 are partially overlapped, and an arrangement area of an antenna array on the frequency band 3 does not overlap with the arrangement area of the antenna array on the frequency band 1 and the arrangement area of the antenna array on the frequency band 2, that is, a partition arrangement. Correspondingly, a coverage space area of electromagnetic wave beams on the frequency band 1 and a coverage space area of electromagnetic wave beams on the frequency band 2 are partially overlapped, and a coverage space area of electromagnetic wave beams on the frequency band 3 does not overlap with the coverage space area of the electromagnetic wave beams on the frequency band 1 and the coverage space area of the electromagnetic wave beams on the frequency band 2. FIG. 5(c) shows a schematic diagram in which the arrangement manner of the antenna arrays on the three frequency bands is a completely overlapped arrangement, that is, all arrangement areas of the antenna arrays on the three frequency bands are overlapped. Correspondingly, coverage space areas of electromagnetic wave beams on the three frequency bands are overlapped with each other.

In a solution shown in FIG. 5(b), when coverage areas of electromagnetic wave beams transmitted from an overlapping area of the antenna arrays on the frequency band 1 and the frequency band 2 also overlap with each other, antenna signals on two different frequency bands cover a same space area, so that a communications bandwidth of a same space area can be increased, thereby further increasing a communications capacity of this space area. In a solution shown in FIG. 5(c), when coverage areas of electromagnetic wave beams transmitted from an area in which the antenna arrays on the frequency band 1, the frequency band 2, and the frequency band 3 overlap also overlap with each other, antenna signals on three different frequency bands cover same space, so that a communications bandwidth of a same space area can be increased, thereby further increasing a communications capacity of this space area.

It should be understood that, in this embodiment of the present invention, antenna arrays on different frequency bands are not limited to be absolutely disposed in a same plane. For example, the three arrangement manners shown in FIG. 5(a) and FIG. 5(b) and FIG. 5(c) are arrangement manners, between the antenna arrays on the three frequency bands, that are observed from planes perpendicular to an axis of the focus device. A case shown in FIG. 5(b) is used as an example. In an actual case, the antenna array on the frequency band 1 and the antenna array on the frequency band 2 may be located in different planes. However, viewed from an observation orientation shown in FIG. 5(b), the arrangement area of the antenna array on the frequency band 1 and the arrangement area of the antenna array on the frequency band 2 are partially overlapped. Alternatively, that is, provided that coverage areas of beams that are transmitted respectively by the antenna array on the frequency band 1 and the antenna array on the frequency band 2 and point to the focus device 110 overlap with each other, multiple feasible methods may be adopted to set a relative arrangement manner between the antenna array on the frequency band 1 and the antenna array on the frequency band 2. This embodiment of the present invention does not impose a limitation thereto.

It should be noted that, the arrangement manners between the antenna arrays on the three frequency bands of the tri-band feeding antenna array shown in FIG. 5(a) and FIG. 5(b) and FIG. 5(c) are merely examples, and the present invention is not limited thereto. For example, the multi-band feeding antenna array 110 may include antenna arrays on more frequency bands, and an arrangement manner between the antenna arrays on the frequency bands may be randomly changed. The present invention does not impose a specific limitation.

Therefore, in the antenna system that is based on a focus device and provided in this embodiment of the present invention, compared with a current dual-band shared-aperture antenna on X and Ka frequency bands, an arrangement manner between antenna arrays on different frequency bands of a multi-band feeding antenna array does not have strict dependency and conditionality, and it is only necessary to dispose the antenna arrays on different frequency bands in a focus area 130 of a focus device 110. That is, the arrangement manner between the antenna arrays on different frequency bands is related only to a space range size of the focus area 130, and is not restricted by a working frequency band of an antenna. Therefore, the antenna system provided in this embodiment of the present invention has a higher design flexibility, so as to improve applicability of the antenna system.

Optionally, in this embodiment of the present invention, the antenna arrays on the at least two frequency bands include at least an antenna array on a second target frequency band and an antenna array on a third target frequency band, and sub-beams separately generated by the antenna array on the second target frequency band and the antenna array on the third target frequency band are at least partially overlapped.

It should be understood that, that the sub-beams separately generated by the antenna array on the second target frequency band and the antenna array on the third target frequency band are at least partially overlapped specifically means that areas covered by the sub-beams separately generated by the antenna array on the second target frequency band and the antenna array on the third target frequency band are at least partially overlapped.

Specifically, as shown in FIG. 5(b), the second target frequency band is equivalent to the frequency band 1, and the third target frequency band is equivalent to the frequency band 2. Alternatively, as shown in FIG. 5(c), the second target frequency band and the third target frequency band are respectively equivalent to any two different frequency bands of the frequency band 1, the frequency band 2, and the frequency band 3.

It should be understood that, in an area A in which coverage areas of beams transmitted by the antenna arrays on the first target frequency band and the second target frequency band mutually overlap, that is, antenna signals on two different frequency bands cover the area A, so that a communications bandwidth of the area A can be increased, thereby further increasing a communications capacity of the area A.

Therefore, in the antenna system that is based on a focus device and provided in this embodiment of the present invention, that antenna signals on two different frequency bands cover a same space area can be at least implemented, so that a communications bandwidth of the same space area can be increased, thereby further increasing a communications capacity of this space area.

It should be understood that, an arrangement manner between the antenna array on the second target frequency band and the antenna array on the third target frequency band includes but is not limited to the arrangement manner shown in FIG. 5(b) or FIG. 5(c). Provided that the coverage areas of the beams separately generated by the antenna array on the second target frequency band and the antenna array on the third target frequency band are at least partially overlapped, the arrangement manner between the antenna array on the second target frequency band and the antenna array on the third target frequency band may use multiple feasible setting manners, and this embodiment of the present invention does not impose a limitation thereto.

Therefore, in the antenna system provided in this embodiment of the present invention, additional antenna gains can be obtained by disposing a multi-band feeding antenna array that includes antenna arrays on at least two frequency bands in a focus area of a focus device and using a beam focusing function of the focus device. The multi-band feeding antenna array has at least an antenna array, on a first target frequency band, that includes multiple feeding units arranged in a form of a non-one-dimensional linear array, so that a coverage area of a beam on the first target frequency band can be effectively extended, thereby increasing a communications capacity. Moreover, the multi-band feeding antenna array has at least antenna arrays, on two frequency bands, whose beam coverage areas are mutually overlapped, so that beams on different frequency bands can cover a same space area, and a communications bandwidth and a communications capacity of the same space area can be effectively increased. In addition, in the antenna system and a processing method provided in this embodiment of the present invention, a frequency band ratio between different frequency bands of the multi-band feeding antenna array is not strictly limited, and an arrangement manner between antenna arrays on different frequency bands is not strictly limited either, so that applicability of the antenna system can be effectively improved.

The antenna system provided in this embodiment of the present invention can flexibly implement multiple beams on each frequency band of multiple frequency bands on which the antenna system works. Methods for implementing multiple beams by each frequency band include two manners: feeding based on a single feeding unit, and feeding based on a feeding unit sub-array.

Optionally, in this embodiment of the present invention, the antenna arrays on the at least two frequency bands include at least an antenna array on a fifth target frequency band, where the antenna array on the fifth target frequency band includes multiple feeding units, and at least one feeding unit of the multiple feeding units is configured to receive a feeding signal, and generate a sub-beam based on the feeding signal.

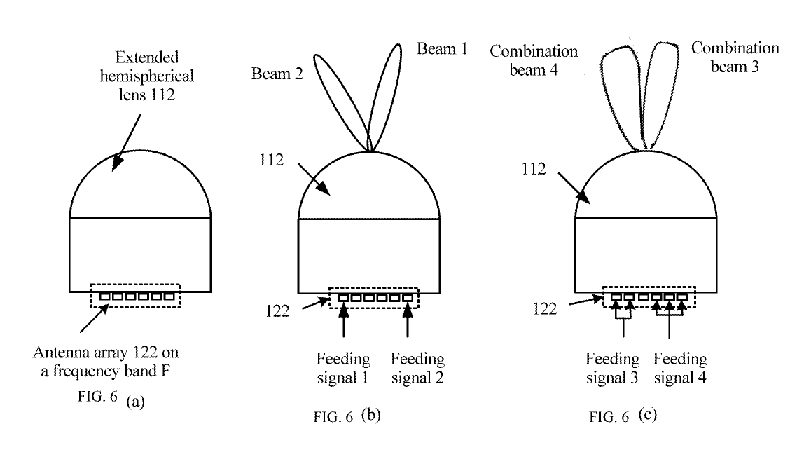

Specifically, for example, the focus device 110 is an extended hemispherical lens 112. FIG. 6(a), FIG. 6(b) and FIG. 6(c) show antenna systems that are implemented based on the extended hemispherical lens 112. For convenience of denotation and description, FIG. 6(a), FIG. 6(b), and FIG. 6(c) only draw an antenna array on a single frequency band F in a multi-band feeding antenna array 120, and it is assumed that the antenna array on the frequency band F includes six feeding units. It should be understood that, the frequency band F shown in FIG. 6(a) and FIG. 6(b) and FIG. 6(c) may correspond to the fifth target frequency band.

Because of a beam convergence function of the focus device 110 (the extended hemispherical lens 112 in FIG. 6(a) and FIG. 6(b) and FIG. 6(c)), one beam of a required gain can be generated by using a single feeding unit, that is, one feeding unit corresponds to one beam. Specifically, as shown in FIG. 6(b), a beam 1 and a beam 2 are implemented by exciting the first feeding unit and the sixth feeding unit at the same time respectively by using a feeding signal 1 and a feeding signal 2. Specifically, the feeding signal 1 generates the beam 1, and the feeding signal 2 generates the beam 2.

A required beam is generated by choosing a quantity and a location of a feeding unit and inputting a feeding signal. It should be understood that, FIG. 6(b) only schematically shows an example of generating two beams by inputting feeding signals to two feeding units, and actual application is not limited thereto. For example, a beam 1 to a beam 6 may be generated by respectively inputting a feeding signal to six feeding signals included in an antenna array on a frequency band F. In actual application, for an antenna array on a single frequency band, feeding units of different quantities and different locations may be chosen according to a specific requirement to excite a feeding signal to generate a required beam.

With reference to FIG. 6(b), the foregoing describes a solution for implementing multiple beams based on a single feeding unit. Multiple beams may be further implemented based on a feeding unit sub-array. Specifically, when a distance between two adjacent feeding units is less than a preset threshold, two beams generated correspondingly by the two adjacent feeding units also gradually come closer, and are overlapped together to form one beam.

Optionally, in this embodiment of the present invention, the antenna arrays on the at least two frequency bands include at least an antenna array on a fifth target frequency band, where the antenna array on the fifth target frequency band includes multiple feeding units, a distance between adjacent feeding units of at least two feeding units of the multiple feeding units is less than a second threshold, and feeding signals received by feeding units of the at least two feeding units are the same.

Specifically, as shown in FIG. 6(c), a combination beam 3 is generated by exciting the first feeding unit and the second feeding unit at the same time by using a feeding signal 3; and a combination beam 4 is generated by exciting the fourth feeding unit, the fifth feeding unit, and the sixth feeding unit at the same time by using a feeding signal 4.

It should be understood that, in an example shown in FIG. 6(c), a distance between the first feeding unit and the second feeding unit is less than the second threshold, a distance between the fourth feeding unit and the fifth feeding unit is less than the second threshold, and a distance between the fifth feeding unit and the sixth feeding unit is also less than the second threshold. That is, if the first, the second, the fourth, the fifth, and the sixth feeding units are excited by separately using a feeding signal according to the solution shown in FIG. 6(b), beams generated by the first feeding unit and the second feeding unit are overlapped together, beams generated by the fourth feeding unit and the fifth feeding unit are overlapped together, and beams generated by the fifth feeding unit and the six feeding unit are also overlapped together. It is also possible that beams separately generated by the fourth feeding unit, the fifth feeding unit, and the sixth feeding unit are mutually overlapped together. Therefore, according to the method shown in FIG. 6(c), the combination beam 3 can be generated by exciting the first feeding unit and the second feeding unit at the same time by using the feeding signal 3; and the combination beam 4 can be generated by exciting the fourth feeding unit, the fifth feeding unit, and the sixth feeding unit at the same time by using the feeding signal 4.

Therefore, during design of the antenna system provided in this embodiment of the present invention, a distance between adjacent feeding units may be controlled to be less than a preset threshold, to ensure that beams corresponding to the adjacent feeding units are overlapped. Therefore, the two adjacent feeding units may serve as one feeding unit sub-array, so that one feeding signal is used to excite the feeding unit sub-array so as to generate a combination beam that has a wider beam width.

It should be further understood that, the feeding unit sub-array mentioned in this embodiment of the present invention is not limited to including two adjacent feeding units or three feeding units shown in FIG. 6(c). For example, all distances between any two of the six feeding units included in the antenna array on the frequency band 1 are less than the second threshold. That is, when the six feeding units are fed separately, and beams generated correspondingly are overlapped, the six feeding units may be considered as one feeding unit sub-array, so that the six feeding units can be excited at the same time by using one feeding signal, so as to further generate a combination beam that has a wider beam width.

Therefore, in the antenna system provided in this embodiment of the present invention, a distance between adjacent feeding units can be controlled, so that beams separately formed by the adjacent feeding units are overlapped, and therefore, a beam of any width can be implemented. That is, a beam width can be controlled by choosing an array scale of a feeding unit sub-array excited by a feeding signal, so as to further implement an antenna system in which the beam width is adjustable.

In actual application, if a high gain scenario (corresponding to narrow beam angle coverage) is needed, a feeding unit sub-array of a relatively small scale is chosen to perform feeding signal excitation to implement a narrow-beam high-gain characteristic; and if a wide angle coverage scenario is needed, a feeding unit sub-array of a relatively large scale is chosen to perform feeding signal excitation to implement a wide-beam wide-angle coverage characteristic.

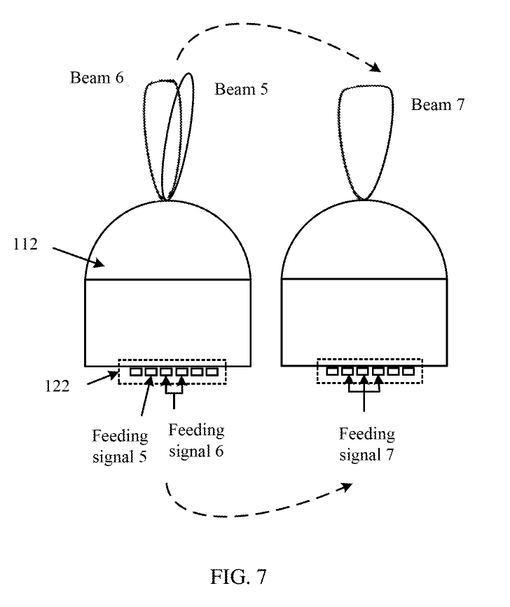

Specifically, the antenna system based on the extended hemispherical lens 112 is still used as an example. FIG. 7 shows a schematic diagram of a method for switching different feeding manners in different application scenarios. Likewise, for convenience of denotation and description, FIG. 7 only draws an antenna array on a single frequency band F of a multi-band feeding antenna array 120, and it is assumed that the antenna array on the frequency band F includes six feeding units. For example, in a first scenario in which a high gain is needed, as shown in the left schematic diagram of FIG. 7, the second feeding unit is excited by using a feeding signal 5, to generate a beam 5 of a narrow width; and the third feeding unit and the fourth feeding unit may be excited at the same time by using a feeding signal 6, to generate a beam 6 of a narrow width. In a second scenario in which wide angle coverage is needed, because the left schematic diagram of FIG. 7 shows that the beam 5 and the beam 6 are overlapped, the second to the fourth feeding units may be considered as one feeding unit sub-array. As shown in the right schematic diagram of FIG. 7, the second to the fourth feeding units are excited at the same time by using a feeding signal 7, to generate a beam 7 of a relatively wide width. That is, the beam 5 and the beam 6 are combined into the beam 7, and a broadening width of the beam 7 is roughly a combination width or an envelope width of the beam 5 and the beam 6.

Therefore, in the antenna system provided in this embodiment of the present invention, an adjustable beam width can be implemented by controlling a distance between adjacent feeding units of an antenna array on a single frequency band.

When feeding a single feeding unit needs to be switched to feeding a feeding unit sub-array that includes two or more feeding units, a switch may be used to implement this switching process.

Specifically, a switch form may be a diode switch, an MEMS switch, or other apparatuses that can implement the function. If each feeding unit is connected to a transceiver, switching of feeding manners may be implemented by means of a DSP or an FPGA manner.

In the antenna system provided in this embodiment of the present invention, consecutive beam scanning can be implemented on each frequency band of multiple frequency bands on which the antenna system works.

Optionally, in this embodiment of the present invention, the antenna arrays on the at least two frequency bands include at least an antenna array on a sixth target frequency band, where the antenna array on the sixth target frequency band includes multiple feeding units, and the multiple feeding units are configured to successively receive a feeding signal according to a time sequence.

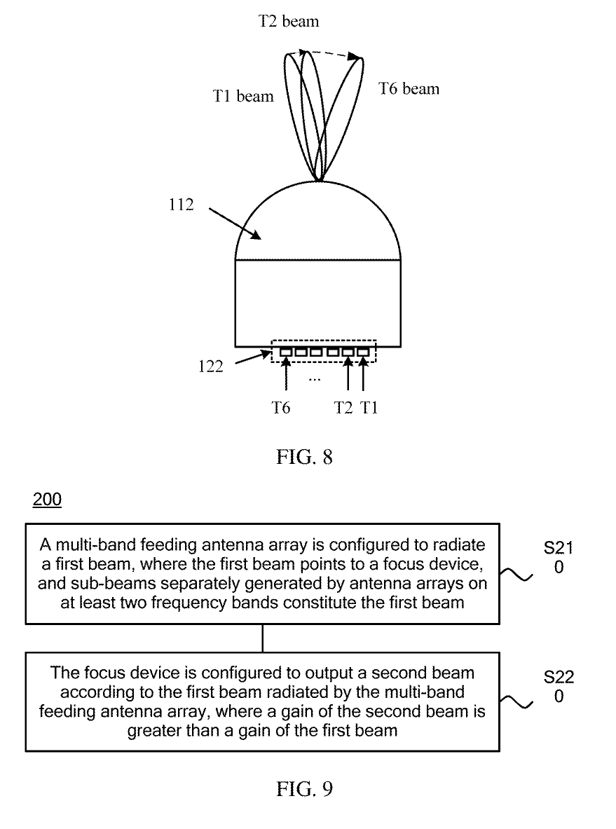

Specifically, the antenna system based on the extended hemispherical lens 112 is still used as an example. FIG. 8 shows a schematic diagram for implementing beam scanning according to a time sequence. Likewise, for convenience of denotation and description, FIG. 8 only draws an antenna array on a single frequency band F of a multi-band feeding antenna array 120, and it is assumed that the antenna array on the frequency band F includes six feeding units. Beam scanning can be implemented by successively performing feeding signal excitation on the first to the sixth feeding units according to a time sequence [T₁ T₂ . . . T6].

In addition, a distance between adjacent feeding units may be further controlled to implement continuous beam scanning, to implement continuous tracking and communications for a user or a target.

FIG. 8 shows a method for performing beam scanning based on a single feeding unit. Similarly, beam scanning may be implemented based on a feeding unit sub-array.

It should be understood that, in the foregoing solutions described with reference to FIG. 6(a) and FIG. 6(b) and FIG. 6(c) to FIG. 8, the antenna array on the single frequency band F of the multi-band feeding antenna array 1200 is used as an example for description. For an antenna array on another frequency band included in the multi-band feeding antenna array 120, a processing method is similar to the methods shown in FIG. 6(a) and FIG. 6(b) and FIG. 6(c) to FIG. 8; for brevity, details are not described herein.

Therefore, in the antenna system provided in this embodiment of the present invention, additional antenna gains can be obtained by disposing a multi-band feeding antenna array that includes antenna arrays on at least two frequency bands in a focus area of a focus device and using a beam focusing function of the focus device. The multi-band feeding antenna array has at least an antenna array, on a first target frequency band, that includes multiple feeding units arranged in a form of a non-one-dimensional linear array, so that a coverage area of a beam on the first target frequency band can be effectively extended, thereby increasing a communications capacity. Moreover, the multi-band feeding antenna array has at least antenna arrays, on two frequency bands, whose beam coverage areas are mutually overlapped, so that beams on different frequency bands can cover a same space area, and a communications bandwidth and a communications capacity of the same space area can be effectively increased. In addition, in the antenna system and a processing method provided in this embodiment of the present invention, a frequency band ratio between different frequency bands of the multi-band feeding antenna array is not strictly limited, and an arrangement manner between antenna arrays on different frequency bands is not strictly limited either, so that applicability of the antenna system can be effectively improved. In addition, multiple beams can be flexibly implemented on each frequency band of multiple frequency bands on which the antenna system works, and this further strengthens the applicability of the antenna system. Further, consecutive beam scanning can be implemented on each frequency band of the multiple frequency bands on which the antenna system works, thereby implementing continuous tracking for a target or communication with a target.

FIG. 9 shows a schematic flowchart of a processing method for an antenna system according to an embodiment of the present invention. The method 200 may be performed by, for example, an antenna system 100. The antenna system 100 includes a focus device and a multi-band feeding antenna array, where the focus device has a beam focusing function, the multi-band feeding antenna array is disposed in a focus area of the focus device, a distance between a boundary point of the focus area and a focal point of the focus device is less than a first threshold, the multi-band feeding antenna array includes antenna arrays on at least two frequency bands, and an antenna array on each frequency band of the at least two frequency bands includes a feeding unit that is configured to receive a feeding signal and generate a sub-beam based on the feeding signal; and the processing method 200 includes the following steps:

S210. The multi-band feeding antenna array is configured to radiate a first beam, where the first beam points to the focus device, and sub-beams separately generated by the antenna arrays on the at least two frequency bands constitute the first beam.

S220. The focus device is configured to receive the first beam radiated by the multi-band feeding antenna array, and output a second beam based on the first beam, where a gain of the second beam is greater than a gain of the first beam.

The antenna arrays on the at least two frequency bands include at least an antenna array on a first target frequency band, where the antenna array on the first target frequency band includes multiple feeding units that are arranged in a form of a non-one-dimensional linear array.

Therefore, in the processing method for an antenna system provided in this embodiment of the present invention, a multi-band feeding antenna array that includes antenna arrays on at least two frequency bands is disposed in a focus area of a focus device, where the multi-band feeding antenna array includes at least an antenna array, on a first target frequency band, that includes multiple feeding units arranged in a form of a non-one-dimensional linear array, so that a coverage area of a beam on the first target frequency band can be effectively extended, thereby increasing a communications capacity. In addition, in the antenna system and the processing method provided in this embodiment of the present invention, a frequency band ratio between different frequency bands of the multi-band feeding antenna array is not strictly limited, and an arrangement manner between antenna arrays on different frequency bands is not strictly limited either, so that applicability of the antenna system can be effectively improved.

Optionally, in this embodiment of the present invention, the antenna arrays on the at least two frequency bands include at least an antenna array on a second target frequency band and an antenna array on a third target frequency band, and sub-beams separately generated by the antenna array on the second target frequency band and the antenna array on the third target frequency band are at least partially overlapped.

Optionally, in this embodiment of the present invention, the antenna arrays on the at least two frequency bands include at least an antenna array on a fourth target frequency band, where the antenna array on the fourth target frequency band includes one feeding unit.

Optionally, in this embodiment of the present invention, the antenna arrays on the at least two frequency bands include at least an antenna array on a fifth target frequency band, where the antenna array on the fifth target frequency band includes multiple feeding units, a distance between adjacent feeding units of at least two feeding units of the multiple feeding units is less than a second threshold, and feeding signals received by feeding units of the at least two feeding units are the same.

Refer to the foregoing description with reference to FIG. 6(a) and FIG. 6(b) and FIG. 6(c) for details; for brevity, details are not described herein.

In actual application, if a high gain scenario (corresponding to narrow beam angle coverage) is needed, a feeding unit sub-array of a relatively small scale is chosen to perform feeding signal excitation to implement a narrow-beam high-gain characteristic; and if a wide angle coverage scenario is needed, a feeding unit sub-array of a relatively large scale is chosen to perform feeding signal excitation to implement a wide-beam wide-angle coverage characteristic.

Specifically, an antenna system based on an extended hemispherical lens 112 is used as an example. FIG. 7 shows a schematic diagram of a method for switching different feeding manners in different application scenarios. Likewise, for convenience of denotation and description, FIG. 7 only draws an antenna array on a single frequency band F of a multi-band feeding antenna array 120, and it is assumed that the antenna array on the frequency band F includes six feeding units. For example, in a first scenario in which a high gain is needed, as shown in the left schematic diagram of FIG. 7, the second feeding unit is excited by using a feeding signal 5, to generate a beam 5 of a narrow width; and the third feeding unit and the fourth feeding unit may be excited at the same time by using a feeding signal 6, to generate a beam 6 of a narrow width. In a second scenario in which wide angle coverage is needed, because the left schematic diagram of FIG. 7 shows that the beam 5 and the beam 6 are overlapped, the second to the fourth feeding units may be considered as one feeding unit sub-array. As shown in the right schematic diagram of FIG. 7, the second to the fourth feeding units are excited at the same time by using a feeding signal 7, to generate a beam 7 of a relatively wide width. That is, the beam 5 and the beam 6 are combined into the beam 7, and a broadening width of the beam 7 is roughly an envelope width of the beam 5 and the beam 6.

Therefore, in the processing method for an antenna system provided in this embodiment of the present invention, beam width adjustment can be implemented by controlling a distance between adjacent feeding units of an antenna array on a single frequency band.

When feeding a single feeding unit needs to be switched to feeding a feeding unit sub-array that includes two or more feeding units, a switch may be used to implement this switching process.

Specifically, a switch form may be a diode switch, an MEMS switch, or other apparatuses that can implement the function. If each feeding unit is connected to a transceiver, switching of feeding manners may be implemented by means of a DSP or an FPGA manner.

In the antenna system provided in this embodiment of the present invention, consecutive beam scanning can be implemented on each frequency band of multiple frequency bands on which the antenna system works.

Optionally, in this embodiment of the present invention, the antenna arrays on the at least two frequency bands include at least an antenna array on a sixth target frequency band, where the antenna array on the sixth target frequency band includes multiple feeding units, and the multiple feeding units successively receive a feeding signal according to a time sequence.

Refer to the foregoing description with reference to FIG. 8 for details; for brevity, details are not described herein.

Optionally, in this embodiment of the present invention, the focus device includes any one of following devices: an elliptical lens, a spherical lens, an extended hemispherical lens, a Luneburg lens, a paraboloidal reflector, a plane lens, or a Cassegrain dual reflector.

Optionally, in this embodiment of the present invention, antenna types of the antenna arrays on the at least two frequency bands include any one of the following types: a coaxial fed microstrip antenna, a direct feeding microstrip antenna, a coupled feed microstrip antenna, a waveguide slot antenna, a Yagi-Uda antenna, a plane Yagi antenna, a substrate-integrated waveguide slot antenna, a rectangular horn antenna, or a dipole antenna.

Optionally, in this embodiment of the present invention, the arrangement manner of the multiple feeding units included in the antenna array on the first target frequency band includes either one of the following manners: a two-dimensional planar array or a three-dimensional array.

Therefore, in the processing method for an antenna system provided in this embodiment of the present invention, additional antenna gains can be obtained by disposing a multi-band feeding antenna array that includes antenna arrays on at least two frequency bands in a focus area of a focus device and using a beam focusing function of the focus device. The multi-band feeding antenna array has at least an antenna array, on a first target frequency band, that includes multiple feeding units arranged in a form of a non-one-dimensional linear array, so that a coverage area of a beam on the first target frequency band can be effectively extended, thereby increasing a communications capacity. Moreover, the multi-band feeding antenna array has at least antenna arrays, on two frequency bands, whose beam coverage areas are mutually overlapped, so that beams on different frequency bands can cover a same space area, and a communications bandwidth and a communications capacity of the same space area can be effectively increased. In addition, in the antenna system and the processing method provided in this embodiment of the present invention, a frequency band ratio between different frequency bands of the multi-band feeding antenna array is not strictly limited, and an arrangement manner between antenna arrays on different frequency bands is not strictly limited either, so that applicability of the antenna system can be effectively improved. In addition, multiple beams can be flexibly implemented on each frequency band of multiple frequency bands on which the antenna system works, and this further strengthens the applicability of the antenna system. Further, consecutive beam scanning can be implemented on each frequency band of the multiple frequency bands on which the antenna system works, thereby implementing continuous tracking for a target or communication with a target.

It should be understood that sequence numbers of the foregoing processes do not mean execution sequences in various embodiments of the present invention. The execution sequences of the processes should be determined according to functions and internal logic of the processes, and should not be construed as any limitation on the implementation processes of the embodiments of the present invention.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present invention.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific embodiments of the present invention, but are not intended to limit the protection scope of the present invention. Any modification or replacement readily figured out by a person skilled in the art within the technical scope disclosed in the present invention shall fall within the protection scope of the present invention. Therefore, the protection scope of the present invention shall be subject to the protection scope of the claims.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An antenna system, comprising:
a focus device; and
a multi-band feeding antenna array, disposed in a focus area of the focus device, and configured to radiate a first beam, wherein the first beam points to the focus device, and a distance between a boundary point of the focus area and a focal point of the focus device is less than a first threshold;
wherein the focus device is configured to receive the first beam radiated by the multi-band feeding antenna array, and output a second beam based on the first beam, wherein a gain of the second beam is greater than a gain of the first beam;
wherein the multi-band feeding antenna array comprises antenna arrays on a plurality of frequency bands, wherein an antenna array on each frequency band of the plurality of frequency bands comprises a feeding unit that is configured to receive a feeding signal and generate a sub-beam based on the feeding signal, and sub-beams separately generated by the antenna arrays on the plurality of frequency bands constitute the first beam; and
wherein the antenna arrays on the plurality of frequency bands comprise an antenna array on a first target frequency band, wherein the antenna array on the first target frequency band comprises a plurality of feeding units that are arranged in a form of a non-one-dimensional linear array.

2. The antenna system according to claim 1, wherein the antenna arrays on the plurality of frequency bands comprise an antenna array on a second target frequency band and an antenna array on a third target frequency band, and sub-beams separately generated by the antenna array on the second target frequency band and the antenna array on the third target frequency band are at least partially overlapped.

3. The antenna system according to claim 1, wherein the antenna arrays on the plurality of frequency bands comprise an antenna array on a fourth target frequency band, and the antenna array on the fourth target frequency band comprises one feeding unit.

4. The antenna system according to claim 1, wherein the antenna arrays on the plurality of frequency bands comprise antenna array on a fifth target frequency band, the antenna array on the fifth target frequency band comprises a plurality of feeding units, a distance between adjacent feeding units of at least two feeding units in the plurality of feeding units is less than a second threshold, and feeding signals received by feeding units of the plurality of feeding units are the same.

5. The antenna system according to claim 1, wherein the antenna arrays on the plurality of frequency bands comprise an antenna array on a sixth target frequency band, the antenna array on the sixth target frequency band comprises a plurality of feeding units, and the plurality of feeding units are configured to successively receive a feeding signal according to a time sequence.

6. The antenna system according to claim 1, wherein the focus device comprises one of following devices: an elliptical lens, a spherical lens, an extended hemispherical lens, a Luneburg lens, a paraboloidal reflector, a plane lens, and a Cassegrain dual reflector.

7. The antenna system according to claim 1, wherein antenna types of the antenna arrays on the plurality of frequency bands comprise one of the following types: a coaxial fed microstrip antenna, a direct feeding microstrip antenna, a coupled feed microstrip antenna, a waveguide slot antenna, a Yagi-Uda antenna, a plane Yagi antenna, a substrate-integrated waveguide slot antenna, a rectangular horn antenna, and a dipole antenna.

8. The antenna system according to claim 1, wherein an arrangement manner of the plurality of feeding units comprised in the antenna array on the first target frequency band comprises one of the following manners: a two-dimensional planar array and a three-dimensional array.

9. A method for an antenna system, comprising:
radiating a first beam, wherein the first beam points to a focus device, wherein the antenna system comprises the focus device and a multi-band feeding antenna array, the multi-band feeding antenna array is disposed in a focus area of the focus device, a distance between a boundary point of the focus area and a focal point of the focus device is less than a first threshold, the multi-band feeding antenna array comprises antenna arrays on a plurality of frequency bands, and an antenna array on each frequency band of the plurality of frequency bands comprises a feeding unit that is configured to receive a feeding signal and generate a sub-beam based on the feeding signal, and sub-beams separately generated by antenna arrays on the plurality of frequency bands constitute the first beam; and
receiving the first beam radiated by the multi-band feeding antenna array, and outputting a second beam based on the first beam, wherein a gain of the second beam is greater than a gain of the first beam;
wherein the antenna arrays on the plurality of frequency bands comprise an antenna array on a first target frequency band, wherein the antenna array on the first target frequency band comprises a plurality of feeding units that are arranged in a form of a non-one-dimensional linear array.

10. The method according to claim 9, wherein the antenna arrays on the plurality of frequency bands comprise an antenna array on a second target frequency band and an antenna array on a third target frequency band, and sub-beams separately generated by the antenna array on the second target frequency band and the antenna array on the third target frequency band are at least partially overlapped.

11. The method according to claim 9, wherein the antenna arrays on the plurality of frequency bands comprise an antenna array on a fourth target frequency band, and the antenna array on the fourth target frequency band comprises one feeding unit.

12. The method according to claim 9, wherein the antenna arrays on the plurality of frequency bands comprise an antenna array on a fifth target frequency band, the antenna array on the fifth target frequency band comprises a plurality of feeding units, a distance between adjacent feeding units of at least two feeding units in the plurality of feeding units is less than a second threshold, and feeding signals received by feeding units of the plurality of feeding units are the same.

13. The method according to claim 9, wherein the antenna arrays on the plurality of frequency bands comprise an antenna array on a sixth target frequency band, the antenna array on the sixth target frequency band comprises a plurality of feeding units, and the plurality of feeding units successively receive a feeding signal according to a time sequence.

14. The method according to claim 9, wherein the focus device comprises one of following devices: an elliptical lens, a spherical lens, an extended hemispherical lens, a Luneburg lens, a paraboloidal reflector, a plane lens, and a Cassegrain dual reflector.

15. The method according to claim 9, wherein antenna types of the antenna arrays on the plurality of frequency bands comprise one of the following types: a coaxial fed microstrip antenna, a direct feeding microstrip antenna, a coupled feed microstrip antenna, a waveguide slot antenna, a Yagi-Uda antenna, a plane Yagi antenna, a substrate-integrated waveguide slot antenna, a rectangular horn antenna, or a dipole antenna.

16. The method according to claim 9, wherein an arrangement manner of the plurality of feeding units comprised in the antenna array on the first target frequency band comprises one of the following manners: a two-dimensional planar array and a three-dimensional array.
